(19) United States
(12) Patent Application Publication
(10) Pub. No.: US 2003/0081429 A1
(43) Pub. Date: May 1, 2003

(54) Optic-fibere light system

(75) Inventor: Kai Wai Wong, Hong Kong (HK)

Correspondence Address: SUGHRUE, MION, ZINN, MACPEAK & SEAS, PLLC, 2100 Pennsylvania Avenue, N.W., Washington, DC, 20037-3213, US

(73) Assignee: GREATBOND INVESTMENTS LIMITED

(21) Appl. No.: 09/984,389

(22) Filed: Oct. 30, 2001

(51) Int. Cl. F21V 8/00

(52) U.S. Cl. 362/568; 362/554; 362/101

(57) ABSTRACT

The invention comprises a lighting arrangement and an aquarium. The lighting arrangement has a light source, a light conducting conduit, a first part positioning means engageable to, or engaged with, the light source, and a second part positioning means engageable or engaged with the light conducting conduit. The light source and one end of the light conducting conduit can be placed in a position such that the light conducting conduit and the light source are mounted on opposite sides of a sheet of light conducting material so that the light conducting conduit conducts light from the light source. The lighting arrangement can be used to provide decoration within an aquarium.

### BACKGROUND OF THE INVENTION

This invention relates to a lighting arrangement and has been devised particularly, though not necessarily solely, for use to provide lighting within reservoir such as an aquarium ie. a fish tank.

Various types of decoration have been proposed for reservoirs such as aquariums. The owners of aquariums like to provide decorations that are interesting and indeed fascinating. Frequently such owners like to provide lighting within the aquarium to enhance the visual appeal of the aquarium. However such devices usually require that wiring is entered into the water which, as well as having dangers, is also somewhat unsightly in that the wiring will usually extend up one face of the aquarium tank, across an upper edge of the tank and then be entered into the tank.

U.S. Pat. No. 6,086,215 shows a construction with a laser device to provide illumination within a fish tank. However it is still necessary for the power lead to extend across the upper edge of the tank.

### OBJECT OF THE INVENTION

It is therefore an object of the present invention to provide a lighting arrangement and/or an aquarium which will obviate or minimise the foregoing disadvantages in a simple yet effective manner or which will at least provide the public with a useful choice.

### STATEMENT OF THE INVENTION

Accordingly in one aspect the invention consists in a lighting arrangement comprising a light source, a light conducting conduit, first part positioning means engageable to, or engaged with, the light source and a second part positioning means engageable or engaged with the light conducting conduit so that the light source and one end of the light conducting conduit may be placed in a position such that the light conducting conduit and the light source may be mounted on opposite sides of a sheet of light conducting material so that the light conducting conduit conducts light from the light source.

Preferably the light conducting conduit comprises one or more optic fibres.

Preferably the other end of the light conducting conduit provides light to an ornament.

Preferably the first part positioning means and second part positioning means comprise magnetically attractive material.

Preferably the light source is contained in a reflective cover.

In a further aspect the invention consists in an aquarium having walls and a light source according to any one of the preceding paragraphs mounted thereon such that the light source is mounted on the exterior of a wall of the aquarium and the light conduit is mounted on the interior of that wall of the aquarium adjacent the light source.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawings in which,

FIG. 1 is a diagrammatic view partly in cross section of an aquarium according to one preferred form of the invention,

FIG. 2 is a diagrammatic cross section of a light source for use in a lighting arrangement according to one preferred form of the invention,

FIG. 3 is an exploded view of a part positioning means for use in a lighting arrangement and aquarium of the invention,

FIG. 4 is a view of the construction of FIG. 3 in an assembled condition,

FIG. 5 is a cross section on A-A in FIG. 4,

FIGS. 6, 7 and 8 are diagrammatic elevations of decorations usable in an aquarium and using a light source according to the invention.

### DESCRIPTION OF THE PREFERRED EMBODIMENT

Referring to the drawings, a lighting arrangement and an aquarium are provided as follows.

An aquarium 1 is provided which has a plurality of walls indicated at 2 and 3, but also including a front wall opposite wall 3 and an end wall opposite wall 2.

A light source is provided which may comprise a lamp 4 held by a suitable lamp holder 5. The lamp holder 5 is mounted to a fixing plate 6 by means of a mounting nut 7, for example, in substantially known manner. Apertured plates 8 and 9 are provided to provide support to the lamp holder 5. A housing 10 is provided to contain the lamp holder 5 and lamp 4 and the housing 10 which may be formed of a plastics material includes a front face 11 with a central aperture 12. A first part positioning means is provided and this may comprise item 15 as will be described further hereinafter.

Power is provided to the lamp 4 through the lamp holder 5 and a suitable power cable 16.

The first part positioning means 15 comprises a plate 20 into which a pair of channels 21 and 22 are provided into which magnetically attractable blocks 23 and 24 may be positioned.

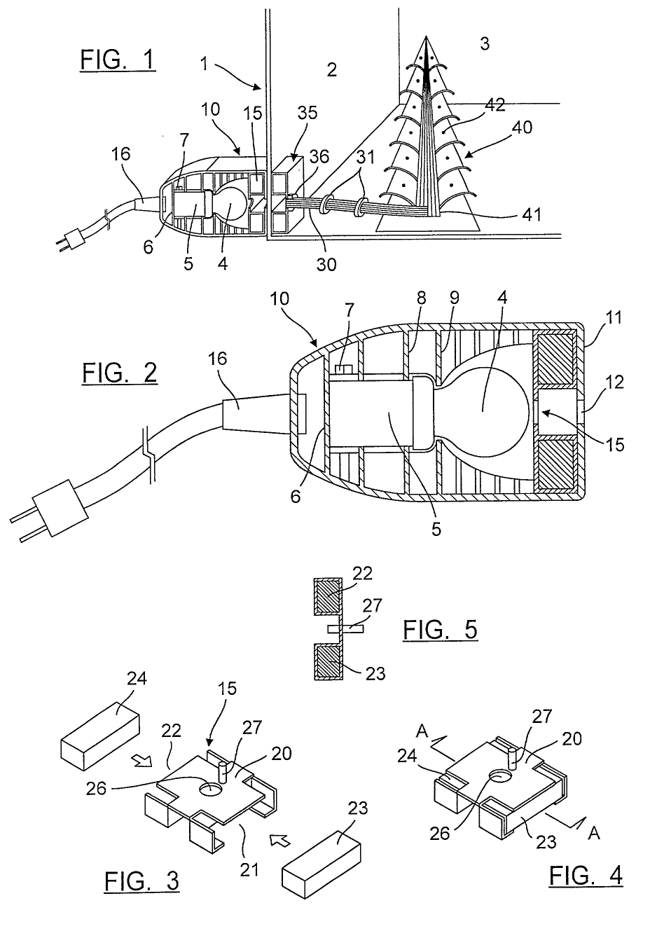

The recesses 21 and 22 may be formed by bending up a base item substantially as shown in FIGS. 3 and 4 or by moulding or otherwise as appropriate.

The base 20 has a central aperture 26 and a locating pin 27 is also provided.

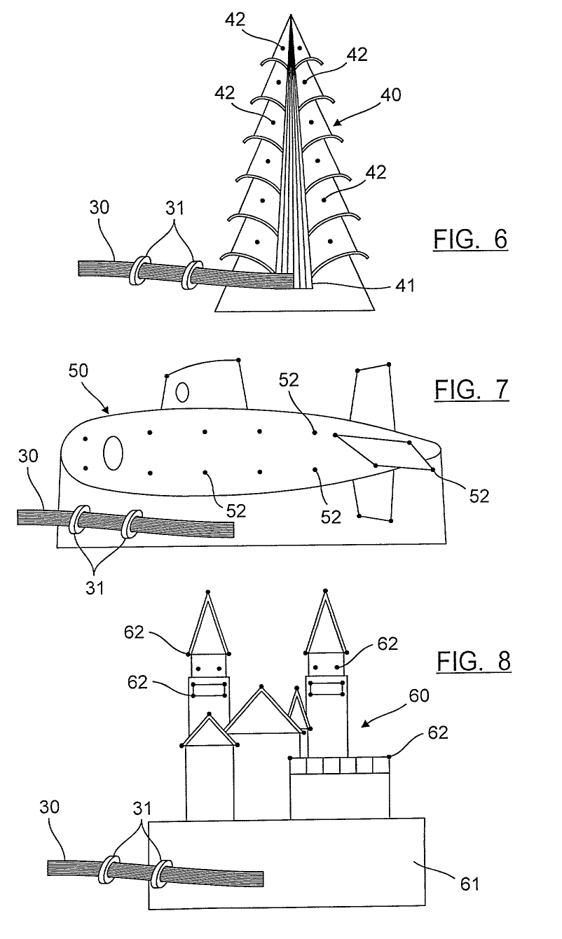

A light conducting conduit 30 is provided which may comprise an optic fibre or more likely a bundle of optic fibres as shown in FIGS. 6, 7 and 8. The optic fibre bundles may be secured by means of plastic belts, such as plastic belts 31.

At one end of the optic fibre bundles 30 is provided a second part positioning means preferably provided by a connector 35 substantially of the type shown in FIGS. 3 and 4 save that the connector 35 is connected to the end 36 of the optic fibre bundle 30 away from a decoration 40.

The magnetically attractable members 23 and 24 on the connector 35 may be a pair of magnets and the items 23 and 24 may be, for example, iron blocks or these items may be reversed or each may be magnets as desired.

The optic fibres such as fibre 41 in the bundle 30 may be led, for example, to any desired light source such as light source 42 in the decoration 40.

As can be seen a number of such light sources are provided. Thus, for example, in relation to the construction of FIG. 6, a number of light sources 42 are provided over the outer surface of the construction. Similarly in the construction of FIG. 7 in which a submarine like item 50 is provided, again with a number of lights such as lights 52. In the construction of FIG. 8, a building 60 is provided on a base 61 and again a number of light sources 62 are provided.

In use, the decoration and cable bundle 30 are placed within the tank and the part positioning means 35 placed adjacent a transparent or translucent wall 2 of the fish tank. The light source is brought up towards the end of the cable such that the pairs of magnetically attractable material 23 and 24 become positioned adjacent one another and magnetic attraction will hold the light source and the cable in the desired position, in particular, so that the light will pass through the aperture 12 and aperture 26 in the mounting block to the equivalent aperture 26 in the block 35 so that light provided by the light source 4 will impinge on the free ends of the cable 30 ultimately lighting the light sources 42. The aperture 12 is made a suitable size so that substantially all light passing through aperture 12 enters the end of the optic fibres forming bundle 30.

Thus it can be seen at least in the preferred form of the invention a lighting arrangement and an aquarium are provided which have the advantage that visually attractive lighting arrangements can be provided within an aquarium without the need for power cables to extend over the edge of the aquarium wall. It is a particular advantage of the construction that there is no direct electrical contact between the external power cable 16 and the interior lights 42, thus creating a safety device as well as providing an uninterrupted visual appearance over the walls of the aquarium.

What is claimed is:

1. A lighting arrangement comprising a light source, a light conducting conduit, first part positioning means engageable to or engaged with the light source, and a second part positioning means engageable or engaged with the light conducting conduit so that the light source and one end of the light conducting conduit may be placed in a position such that the light conducting conduit and the light source may be mounted on opposite sides of a sheet of light conducting material so that the light conducting conduit conducts light from the light source.

2. A lighting arrangement as claimed in claim 1, wherein the light conducting conduit comprises one or more optic fibres.

3. A lighting arrangement as claimed in claim 1, wherein the other end of the light conducting conduit provides light to an ornament.

4. A lighting arrangement as claimed in claim 1, wherein the first part positioning means and second part positioning means comprise magnetically attractive material.

5. A lighting arrangement as claimed in claim 1, wherein the light source is contained in a reflective cover.

6. An aquarium having walls and a light source according to any one of the preceding claims mounted thereon such that the light source is mounted on the exterior of a wall of the aquarium and the light conduit is mounted on the interior of that wall of the aquarium adjacent the light source.
